(19) United States
(12) Patent Application Publication
(10) Pub. No.: US 2024/0057078 A1
(43) Pub. Date: Feb. 15, 2024

(54) METHOD PERFORMED BY USER EQUIPMENT, METHOD PERFORMED BY BASE STATION AND DEVICES THEREOF

(71) Applicant: Samsung Electronics Co., Ltd., Suwon-si (KR)

(72) Inventors: Jingxing FU, Beijing (CN); Feifei SUN, Beijing (CN); Zhe CHEN, Beijing (CN); Miao ZHOU, Beijing (CN)

(21) Appl. No.: 18/446,305

(22) Filed: Aug. 8, 2023

(30) Foreign Application Priority Data
Aug. 10, 2022 (CN) 202210957752.1

(51) Int. Cl. H04W 72/1268; H04L 5/00; H04W 48/12; H04W 72/232

(52) U.S. Cl. CPC H04W 72/1268; H04L 5/0035; H04W 48/12; H04W 72/232

(57) ABSTRACT

The disclosure relates to a 5G or 6G communication system for supporting a higher data transmission rate. A method performed by a UE in a wireless communication system, the method comprising: receiving, from a base station, a first search space ID for a first cell and a second search space ID for a second cell, the first search space ID and the second search space ID being same; receiving, from the base station on the first cell, first DCI for scheduling a PUSCH for one or more cells including the second cell, wherein at least one of a size of the first DCI, blind detection for the first DCI, or a CCE for the first DCI is based on a configuration of the second cell; and transmitting, to the base station, the PUSCH on the one or more cells based on the first DCI.

### CROSS-REFERENCE TO RELATED APPLICATION

This application is based on and claims priority under 35 U.S.C. § 119 to Chinese Patent Application No. 202210957752.1 filed on Aug. 10, 2022, in the Chinese Intellectual Property Office, the disclosure of which is incorporated by reference herein in its entirety.

### BACKGROUND

### 1. Field

The present application relates to the field of communication technology and, specifically, to a method performed by a user equipment, a method performed by a base station, a user equipment, a base station and a computer readable storage medium in a communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beam forming, massive multiple-input multiple-output (MIMO), full-dimensional MIMO (FD-MIMO), array antenna, analog beam forming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FOAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

How to better improve the existing wireless communication methods and better meet the communication needs is a technical problem that technicians in this field have been working on.

### SUMMARY

A method performed by a user equipment (UE) in a wireless communication system, the method comprising: receiving, from a base station, a first search space identifier (ID) for a first cell and a second search space ID for a second cell, the first search space ID and the second search space ID being same; receiving, from the base station on the first cell, first downlink control information (DCI) for scheduling a physical uplink shared channel (PUSCH) for one or more cells including the second cell, wherein at least one of a size of the first DCI, blind detection for the first DCI, or a control channel element (CCE) for the first DCI is based on a configuration of the second cell; and transmitting, to the base station, the PUSCH on the one or more cells based on the first DCI.

A user equipment (UE) in a wireless communication system, the UE comprising: a transceiver; and a controller coupled with the transceiver and configured to: receive, from a base station, a first search space identifier (ID) for a first cell and a second search space ID for a second cell, the first search space ID and the second search space ID being same; receive, from the base station on the first cell, first downlink control information (DCI) for scheduling a physical uplink shared channel (PUSCH) for one or more cells including the second cell, wherein at least one of a size of the first DCI, blind detection for the first DCI, or a CCE for the first DCI is based on a configuration of the second cell; and transmit, to the base station, the PUSCH on the one or more cells based on the first DCI.

A method performed by a base station in a wireless communication system, the method comprising: transmitting, to a user equipment (UE), a first search space identifier (ID) for a first cell and a second search space ID for a second cell, the first search space ID and the second search space ID being same; transmitting, to the UE on the first cell, first downlink control information (DCI) for scheduling a physical uplink shared channel (PUSCH) for one or more cells including the second cell, wherein at least one of a size of the first DCI, blind detection for the first DCI, or a control channel element (CCE) for the first DCI is based on a configuration of the second cell; and receiving, from the UE, the PUSCH on the one or more cells based on the first DCI.

Abase station in a wireless communication system, the base station comprising: a transceiver; and a controller coupled with the transceiver and configured to: transmit, to a user equipment (UE), a first search space identifier (ID) for a first cell and a second search space ID for a second cell, the first search space ID and the second search space ID being same; transmit, to the UE on the first cell, first downlink control information (DCI) for scheduling a physical uplink shared channel (PUSCH) for one or more cells including the second cell, wherein at least one of a size of the first DCI, blind detection for the first DCI, or a control channel element (CCE) for the first DCI is based on a configuration of the second cell; and receive, from the UE, the PUSCH on the one or more cells based on the first DCI.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

In order to more clearly and easily illustrate and understand the technical solutions in the embodiments of the present application, the following is a brief description of the accompanying drawings that need to be used in the description of the embodiments of the present application.

FIG. 1 illustrates an example of wireless network according to various embodiments of the present application;

FIG. 2A illustrates an example of wireless transmission path according to various embodiments of the present application;

FIG. 2B illustrates an example of wireless reception path according to various embodiments of the present application;

FIG. 3A illustrates an example of user equipment according to various embodiments of the present application;

FIG. 3B illustrates an example of base station according to various embodiments of the present application;

FIG. 4 illustrates a flowchart of a method performed by a user equipment in a communication system provided by an embodiment of the present application;

FIG. 5 illustrates a cross-carrier scheduling according to various embodiments of the present application;

FIG. 6 illustrates an example for performing scheduling by a PDCCH in a linked search space according to various embodiments of the present application;

FIG. 7 illustrates an example for performing scheduling by a PDCCH in a linked search space provided by an embodiment of the present application;

FIG. 8 illustrates a flowchart of a communication method performed by a base station in a communication system provided by an embodiment of the present application;

FIG. 9 illustrates a user equipment in a wireless communication system provided by an embodiment of the present application; and

FIG. 10 illustrates a base station in a wireless communication system provided by an embodiment of the present application.

### DETAILED DESCRIPTION

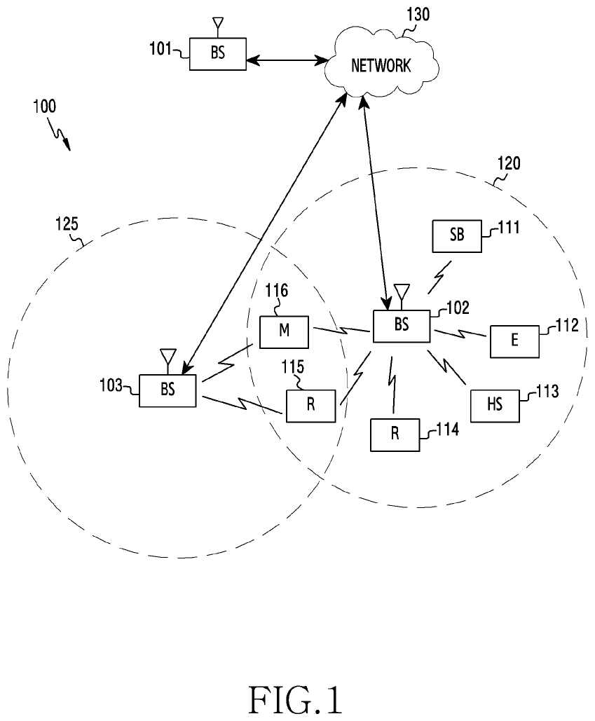

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The purpose of the present application is to be able to solve at least one of the technical defects in the existing communication methods to better meet the communication needs. In order to achieve this purpose, the technical solutions provided in the present application are as follows.

According to a first aspect of the embodiments of the present disclosure, there is provided a method performed by a user equipment in a communication system, the method may include: receiving, from a base station, first configuration information including information of a serving cell whose physical downlink shared channel (PDSCH) and/or physical uplink shared channel (PUSCH) are/is scheduled by one downlink control information (DCI); determining, based on the first configuration information, a non-overlapped control channel element (CCE) index of a physical downlink control channel (PDCCH) candidate; detecting the DCI based on the non-overlapped CCE index; receiving, based on the detected DCI, a PDSCH and/or a PUSCH of at least one serving cell scheduled by the DCI.

As an implementation, the information of the serving cell whose PDSCH and/or PUSCH are/is scheduled by one DCI may include at least one of information of a mapping relationship between a specified field value in the DCI and at least one scheduled serving cell; information of a mapping relationship between a newly added field value in the DCI and at least one scheduled serving cell; information of a mapping relationship between a combination of a specified field value and a newly added field value in the DCI and at least one scheduled serving cell.

As an implementation, the specified field is a carrier indicator (CI) field in the DCI.

As an implementation, the determining, based on the first configuration information, the non-overlapped CCE index of the PDCCH candidate may include: determining the non-overlapped CCE index of the PDCCH candidate based on a reference specified field value, wherein the reference specified field value is one of a plurality of specified field values included in the information of the mapping relationship.

As an implementation, the reference specified field value is determined by a signaling received from the base station for indicating the reference specified field value; or the reference specified field value is determined by a predefined rule; or the reference specified field value is predefined.

As an implementation, the method may further include: receiving, from the base station, second configuration information including configuration information of a search space; configuring, based on the configuration information of the search space, a linked search space of a scheduling serving cell with one of the at least one scheduled serving cell.

As an implementation, the scheduling serving cell corresponds to a plurality of search spaces, each of the plurality of search spaces is linked with a different scheduled serving cell of the at least one scheduled serving cell respectively.

As an implementation, the scheduling serving cell corresponds to one search space, the search space is linked with one scheduled serving cell of the at least one scheduled serving cell.

As an implementation, the detecting the DCI based on the non-overlapped CCE index may include: detecting the DCI at a location corresponding to the non-overlapped CCE index of the PDCCH candidate, based on the linked search space; wherein the DCI is used to determine the at least one serving cell scheduled by the DCI among serving cells configured with the user equipment.

According to a second aspect of the embodiments of the present disclosure, there is provided a method performed by a base station in a communication system, the method may include: determining information of a serving cell whose physical downlink shared channel (PDSCH) and/or physical uplink shared channel (PUSCH) are/is scheduled by one downlink control information (DCI); generating DCI based on the information of the serving cell whose PDSCH and/or PUSCH are/is scheduled by one DCI, transmitting a physical downlink control channel (PDCCH) candidate including the DCI; transmitting, to a user equipment, first configuration information including the information of the serving cell whose PDSCH and/or PUSCH are/is scheduled by one DCI; wherein the information of the serving cell whose PDSCH and/or PUSCH are/is scheduled by one DCI is used by the user equipment to determine a non-overlapped control channel element (CCE) index of the PDCCH candidate.

As an implementation, the information of the serving cell whose PDSCH and/or PUSCH are/is scheduled by one DCI may include at least one of information of a mapping relationship between a specified field value in the DCI and at least one scheduled serving cell; information of a mapping relationship between a newly added field value in the DCI and at least one scheduled serving cell; information of a mapping relationship between a combination of a specified field value and a newly added field value in the DCI and at least one scheduled serving cell.

As an implementation, the specified field is a carrier indicator (CI) field in the DCI.

As an implementation, the method may further include: transmitting, to the user equipment, an instruction for indicating a reference specified field value, wherein the reference specified field value is used by the user equipment to determine the non-overlapped CCE index of the PDCCH candidate.

As an implementation, the method may further include: transmitting, to the user equipment, second configuration information including configuration information of a search space; wherein the configuration information of the search space is used to configure a linked search space of a scheduling serving cell with one of at least one scheduled serving cell.

As an implementation, the scheduling serving cell may correspond to a plurality of search spaces, each of the plurality of search spaces is linked with a different scheduled serving cell of the at least one scheduled serving cell respectively; or the scheduling serving cell corresponds to one search space, the search space is linked with one scheduled serving cell of the at least one scheduled serving cell.

According to a third aspect of the embodiments of the present disclosure, there is provided a user equipment, which may include a transceiver; and a processor coupled to the transceiver and configured to perform the above method performed by a user equipment.

According to a fourth aspect of the embodiments of the present disclosure, there is provided a base station, which may include a transceiver; and a processor, coupled to the transceiver and configured to perform the above method performed by a base station.

According to a fifth aspect of the embodiments of the present disclosure, there is provided an electronic device, including: at least one processor; and at least one memory storing computer-executable instructions, wherein the computer-executable instructions, when run by the at least one processor, cause the at least one processor to perform any one of the methods as described above.

According to a sixth aspect of embodiments of the present disclosure, there is provided a computer-readable storage medium storing instructions, wherein the instructions, when run by at least one processor, cause the at least one processor to perform the methods as described above.

The technical solutions provided by the embodiments of the present disclosure brings at least the following beneficial effect: one configured DCI may simultaneously schedule a PDSCH and/or PUSCH of at least one serving cell, thereby saving resources occupied by a PDCCH that schedules the PDSCH/PUSCH.

In addition, according to the number of PDCCH candidates for different scheduled serving cells simultaneously scheduled by one configured DCI, the number of PDCCH candidates of the linked search space may be reasonably configured in the appropriate scheduled serving cell, so that the number of PDCCH candidates of the scheduled serving cell does not exceed the maximum number of PDCCH candidates allowed.

The beneficial effects brought by the technical solutions provided by the embodiments of the present application will be described later in connection with specific optional embodiments, or may be known from the description of the embodiments, or may be learned from the implementation of the embodiments.

Embodiments of the present application are described below in connection with accompanying drawings in the present application. It is to be understood that the embodiments set forth below in connection with the accompanying drawings are exemplary descriptions for explaining the technical solutions of the embodiments of the present application and do not constitute a limitation of the technical solutions of the embodiments of the present application.

It will be understood by those skilled in the art that, unless specifically stated, the singular forms “one,” “a,” “said,” and “the” used herein may also include the plural form. It should be further understood that the terms “includes” and “comprises” as used in the embodiments of the present application mean that the corresponding features may be implemented as the features, information, data, steps, operations, elements and/or components presented, but do not exclude the implementation of other features, information, data, steps, operations, elements, components and/or combinations thereof supported in the art. It should be understood that when referring to an element being “connected” or “coupled” to another element, the component may be directly connected or coupled to the other element, or it may refer to the element and the other element being connected through an intermediate element. In addition, the “connect” or “couple” as used herein may include wireless connection or wireless coupling. The term “and/or” as used herein indicates at least one of the items defined by the term, for example, “A and/or B” may be implemented as “A,” or “B,” or “A and B.” When describing multiple (two or more) items, if the relationship between the multiple items is not explicitly defined, the multiple items may refer to one, more than one, or all of the multiple items, for example, the description “a parameter A includes A1, A2, A3” may be implemented that the parameter A includes A1 or A2 or A3, or that the parameter A includes at least two of the three parameters A1, A2, and A3.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. A gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB.” For convenience, the terms “gNodeB” and “gNB” are used in this patent document to refer to network infrastructure components that provide wireless access for remote terminals. And, depending on the type of the network, other well-known terms such as “mobile station,” “user station,” “remote terminal,” “wireless terminal” or “user apparatus” can be used instead of “user equipment” or “UE.” For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

A gNB 102 provides wireless broadband access to the network 130 for a first plurality of user equipments (UEs) within a coverage area 120 of gNB 102. The first plurality of UEs include a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. A gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

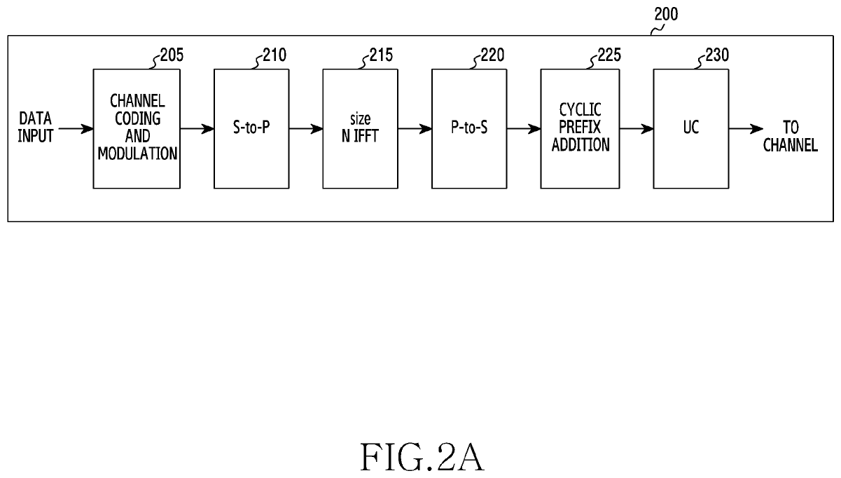

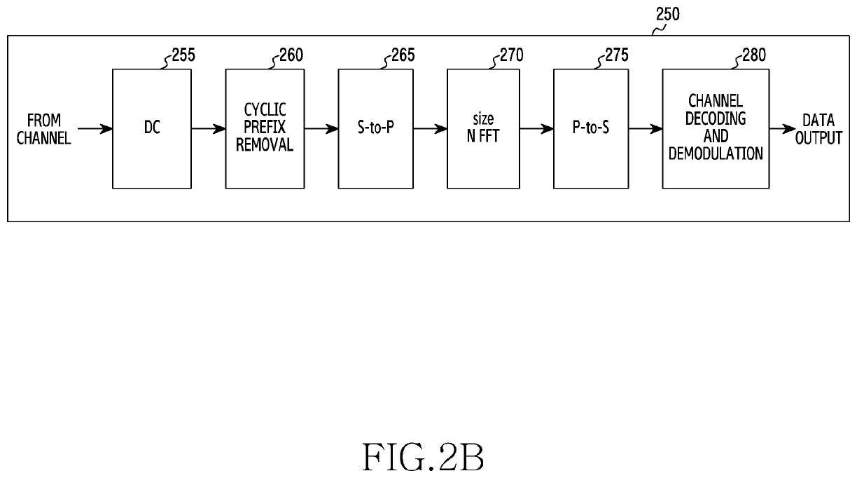

FIGS. 2A and 2B illustrate example wireless transmission and reception paths according to the present disclosure. In the following description, the transmission path 200 can be described as being implemented in a gNB, such as a gNB 102, and the reception path 250 can be described as being implemented in a UE, such as a UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in a gNB 102 and a UE 116. The size N IFFT block 215 performs IFFT operations on the N parallel symbol streams to generate a time-domain output signal. The Parallel-to-serial block 220 converts (such as multiplexes) parallel time-domain output symbols from the size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from a gNB 102 arrives at a UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The Serial-to-parallel block 265 converts the time-domain baseband signal into a parallel time-domain signal. The Size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

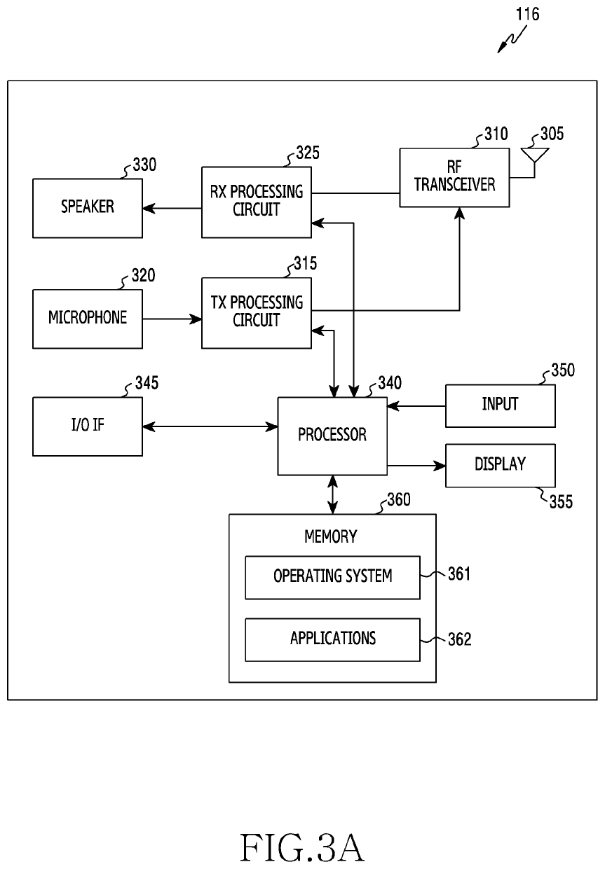

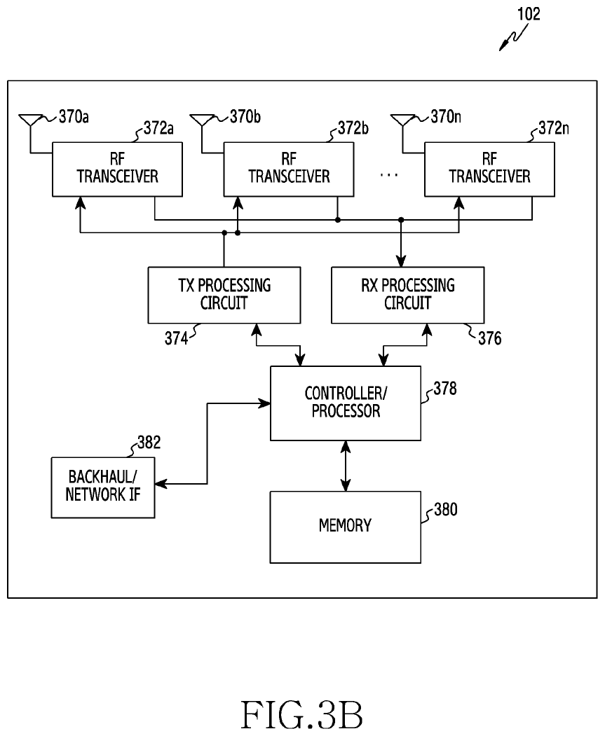

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

A UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of a UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It is understood that the solutions provided by the embodiments of the present application may be applicable to, but not limited to, the wireless network described above.

In a communication system, a transmission from a base station to a user equipment (UE) is referred to as a downlink, and a transmission from an UE to a base station is referred to as an uplink.

The downlink corresponds to a downlink transmission (which may also be called downlink sending or downlink emitting, etc.), and the downlink transmission includes at least one of transmissions of a downlink channel and a downlink signal, where the downlink channel includes a physical downlink shared channel (PDSCH), and a physical downlink control channel (PDCCH), and the downlink signal may include but is not limited to a downlink reference signal. Among them, the PDSCH is scheduled by a downlink control information (DCI) in the PDCCH.

An uplink transmission includes at least one of transmissions of an uplink channel and an uplink signal, wherein the uplink channel includes a physical uplink shared channel (PUSCH), a physical uplink control channel (PUCCH), and a physical random access channel (PRACH), and the uplink signal may include but is not limited to an uplink reference signal. Among them, the PUSCH is scheduled by the downlink control information (DCI) in the PDCCH.

A PDSCH/PUSCH may be scheduled by a PDCCH of a same serving cell (the serving cell may also be called a component carrier (CC)) with the PDSCH/PUSCH, which is called self-carrier-scheduling, or the PDSCH/PUSCH may be scheduled by a PDCCH of a different serving cell from the PDSCH/PUSCH, which is called cross-carrier-scheduling. Among them, a cell that transmits the PDCCH is called a scheduling serving cell, and a cell that transmits the PDSCH/PUSCH is called a scheduled serving cell.

For cross-carrier scheduling, a search space identify (searchSpaceId=a) of a search space is configured in a scheduling serving cell c1, and a search space identity (searchSpaceId=a) of a search space is configured in a scheduled serving cell c2, The search space configured for the scheduling serving cell c1 with the search space identify of searchSpaceId=a and the search space configured for the scheduled serving cell c2 with the search space identify of searchSpaceId=a are called as a linked search space, and a PDCCH in the search space of the scheduling serving cell c1 cross-carrier schedules a PDSCH/PUSCH of the scheduled serving cell c2.

The search space for transmitting DCI includes a common search space (CSS) set and a user equipment (UE) specific search space (USS) set. For CSS, any UE may perform demodulating and decoding, while for USS, only a specific UE may perform demodulating and decoding. The format of the DCI may be divided into a DCI format for scheduling a PDSCH (for example, DCI format 1-0, DCI format 1-1, and DCI format 1-2) and a DCI format for scheduling a PUSCH (for example, DCI format 0-0, DCI format 0-1, and DCI format 0-2).

For a scheduled serving cell, the number of DCI formats with different payload sizes for blind detection of each scheduled serving cell is less than or equal to a certain number (for example, the certain number is equal to 4).

For a scheduled serving cell, the maximum number of monitored PDCCH candidates, denoted as M_{PDCCH}^{max,slot,μ}, is the maximum number of PDCCH candidates to be detected in a time slot μ for the scheduling of this serving cell. The number of PDCCH candidate detections for each scheduled serving cell is determined/identified by a high-layer signaling configuration or by a protocol, and is determined/identified by a search space configuration of each scheduled serving cell.

For a scheduled serving cell, the maximum number of non-overlapped control channel elements (CCEs), denoted as C_{PDCCH}^{max,slot,μ}, is the maximum number of non-overlapped CCEs occupied by PDCCH candidates for the scheduling of this serving cell within a time slot μ.

A CCE index of a PDCCH candidate may be determined/identified according to the parameter cif-InSchedulingCell configured by a high-layer signaling as described below.

For a search space set s associated with CORESET p, the CCE indexes for aggregation level L corresponding to PDCCH candidate m_{s,n}_{_{CI}} of the search space set in slot n_{s,f}^{μ} for an active DL BWP of a serving cell corresponding to carrier indicator field value n_{CI} are given by Equation (1) below:

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i \qquad ( 1 )$$

Wherein, for any CSS, Y_{p,n}_{_{s,f}}_{^{μ}}=0 ;
for a USS, Y_{p,n}_{_{s,f}}_{^{μ}}=(Aₚ·Y_{p,n}_{_{s,f}}_{^{μ}}₋₁)mod D, Y_{p,-1}=n_{RNTI}≠0, Aₚ=39827 for p mod3=0, Aₚ=39829 for p mod3=1, Aₚ=39839 for p mod3=2, and D=65537;
i=0, . . . , L−1;
N_{CCE,p} is the number of CCEs, numbered from 0 to N_{CCE,p}−1, in CORESET p;
n_{CI} is the carrier indicator field value if the UE is configured with a carrier indicator field by CrossCarrierSchedulingConfig for the serving cell on which PDCCH is monitored; otherwise, including for any CSS, n_{CI}=0;
m_{s,n}_{_{CI}}=0, . . . M_{s,n}_{_{CL}}^{(L)}−1, where M_{s,n}_{_{CL}}^{(L)} is the number of PDCCH candidates the UE is configured to monitor for aggregation level L of a search space set s for a serving cell corresponding to n_{CI};
for any CSS, M_{s,max}^{(L)}=M_{s,o}^{(L)}; and
for a USS, M_{s,max}^{(L)} is the maximum of M_{s,n}_{_{CL}}^{(L)} over all configured n_{CI} values for a CCE aggregation level L of search space set s.

The IE CrossCarrierSchedulingConfig is used to specify the configuration when the cross-carrier scheduling is used in a serving cell. CrossCarrierSchedulingConfig information elements are shown in Table 1 below.

TABLE 1

```
CrossCarrierSchedulingConfig ::= SEQUENCE {
  schedulingCellInfo CHOICE {
  own SEQUENCE {
    cif-Presence BOOLEAN
  },
  other SEQUENCE {
    schedulingCellId ServCellIndex,
    cif-InSchedulingCell INTEGER (1..7)
  }
  },
  ...
}
```

The IE Search Space defines how/where to search for PDCCH candidates. Each search space is associated with one ControlResourceSet. For a scheduled cell in the case of cross-carrier scheduling, except for nrofCandidates, all the optional fields are absent.

Search space information elements are shown in Table 2 below.

TABLE 2

| | |
|---|---|
| SearchSpace ::= | SEQUENCE { |
| searchSpaceId | SearchSpaceId, |

Search space field descriptions are shown in Table 3 below.

TABLE 3
SearchSpace field descriptions

```
  searchSpaceId
  Identity of the search space. The searchSpaceId is unique among the BWPs of a Serving cell. In case
of cross carrier scheduling, search spaces with the same searchSpaceId in scheduled cell and scheduling
cell are linked to each other.
```

Currently, one PDCCH may only schedule a PDSCH/PUSCH of one serving cell, regardless of self-carrier-scheduling or cross-carrier-scheduling, for example, the UE is configured with two serving cells, i.e., a serving cell 1 and a serving cell 2, and a PDCCH of the serving cell 1 schedules a PDSCH/PUSCH of the serving cell 1, which is called self-carrier-scheduling, and the PDCCH of serving cell 1 schedules a PDSCH/PUSCH of the serving cell 2, which is called cross-carrier-scheduling.

The above description is a method for scheduling a PDSCH/PUSCH of only one serving cell by one PDCCH.

For a UE configured with one PDCCH for scheduling a PDSCH/PUSCH of at least one serving cell, the total number of detections of PDCCH candidates scheduling all configured serving cells in a time slot μ is recorded as M_{PDCCH}^{total,slot,μ}, the total number cannot exceed a limited value, otherwise the UE may not be able to detect PDCCH candidates.

In order to reduce the resources occupied by the PDCCH scheduling the PDCCH/PUSCH, the present disclosure provides a DCI in a PDCCH that simultaneously schedules a PDCCH/PUSCH of at least one serving cell. At this time, research is needed on how to determine the number of blind detection (BD) for PDCCH candidates and a non-overlapped CCE index.

In this disclosure, a PDCCH candidate may also be referred to as a candidate PDCCH, or may be referred to as a term with the same or similar meaning.

The technical solutions of the present application and how the technical solutions of the present application solve the above technical problem are described in detail below in specific embodiments. The following specific embodiments may be combined with each other, and the same or similar concepts or processes may not be repeated in some embodiments. The exemplary embodiments of the present disclosure are described below in conjunction with the accompanying drawings. The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

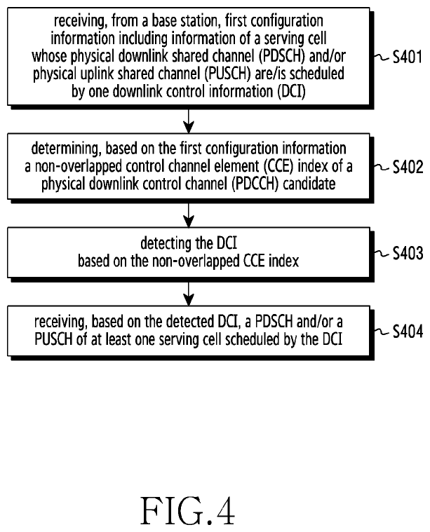

FIG. 4 illustrates a flowchart of a method performed by a user equipment in a communication system provided in an embodiment of the present application.

As illustrated in FIG. 4, at step S401, first configuration information is received from a base station, and the first configuration information may include information of a serving cell whose physical downlink shared channel (PDSCH) and/or physical uplink shared channel (PUSCH) are/is scheduled by one downlink control information (DCI). In the present disclosure, the DCI in the first configuration information may simultaneously schedule at least one serving cell.

According to the embodiment of the present disclosure, the information of the serving cell whose PDSCH and/or PUSCH are/is scheduled by one DCI may include at least one of information of a mapping relationship between a specified field value in the DCI and at least one scheduled serving cell; information of a mapping relationship between a newly added field value in the DCI and at least one scheduled serving cell; information of a mapping relationship between a combination of a specified field value and a newly added field value in the DCI and at least one scheduled serving cell. The specified field may be a carrier indicator (CI) field in the DCI.

DCI in a PDCCH schedules N serving cells out of M serving cells (N is less than or equal to M), and the N serving cells scheduled by the DCI may be indicated by an existing field and/or a newly added field in the DCI.

As a first example, an existing field in the DCI (e.g., a CI field (i.e., cif-InSchedulingCell, also noted as n_{CI})) may be used to indicate serving cells scheduled by the DCI. For example, CI=000, a PDSCH of a serving cell 1 is scheduled; CI=001, PDSCHs of the serving cell 1 and a serving cell 2 are scheduled; CI=010, PDSCHs of the serving cell 1 and a serving cell 3 are scheduled; etc. Table 4 illustrates an example of a mapping relationship between a CI field and a scheduled serving cell. The mapping relationship between the CI field and at least one scheduled serving cell in Table 4 is only exemplary, and the mapping relationship may be changed.

TABLE 4
The mapping relationship between the CI
field and the scheduled serving cell

| CI | scheduled serving cell |
|---|---|
| 000 | serving cell 1 |
| 001 | serving cell land serving cell 2 |
| 010 | serving cell land serving cell 3 |
| 011 | configured serving cell group |
| 100 | configured serving cell group |
| 101 | reserved |
| 110 | reserved |
| 111 | reserved |

As a second example, the serving cells scheduled by the DCI may be indicated by adding a new field to the DCI (e.g., a S field). For example, S=000, a PDSCH of a serving cell 1 is scheduled; S=001, PDSCHs of the serving cell 1 and a serving cell 2 are scheduled; S=011, PDSCHs of the serving cell 1 and a serving cell 3 are scheduled; etc. Table 5 illustrates an example of a mapping relationship between a S field and a scheduled serving cell. The mapping relationship between the S field and at least one scheduled serving cell in Table 5 is only exemplary, and the mapping relationship may be changed.

TABLE 5
The mapping relationship between the S
field and the scheduled serving cell

| S | scheduled serving cell |
|---|---|
| 000 | serving cell 1 |
| 001 | serving cell 1 and serving cell 2 |
| 010 | serving cell 1 and serving cell 3 |
| 011 | configured serving cell group |
| 100 | configured serving cell group |
| 101 | reserved |
| 110 | reserved |
| 111 | reserved |

As a third example, an existing field (e.g., a CI field) and a newly added field (e.g., a S field) in the DCI may be used to indicate serving cells scheduled by the DCI. For example, CI=000 and S=000, a PDSCH of a serving cell 1 is scheduled; CI=000 and S=001, PDSCHs of the serving cell 1 and a serving cell 2 are scheduled; CI=001 and S=000, a PDSCH of a serving cell 3 is scheduled; CI=001 and S=001, PDSCHs of the serving cell 2 and a serving cell 3 are scheduled. Table 6 illustrates an example of a mapping relationship between a CI field and S field and a scheduled serving cell. The mapping relationship between the CI field and S field and at least one scheduled serving cell in Table 6 is only exemplary, and the mapping relationship may be changed.

TABLE 6
The mapping relationship between the CI and
S fields and the scheduled serving cell

| CI | S | scheduled serving cell |
|---|---|---|
| 000 | 000 | serving cell 1 |
| 000 | 001 | serving cell 1 and serving cell 2 |
| 001 | 000 | serving cell 1 and serving cell 3 |
| 001 | 001 | configured serving cell group |
| | 100 | reserved |
| | 101 | reserved |
| | 110 | reserved |
| | 111 | reserved |

The above examples are exemplary only and the present disclosure is not limited thereto. The field values of other fields in the DCI may be modified to indicate at least one serving cell that is scheduled simultaneously, based on the above ideas.

At step S402, a non-overlapped control channel element (CCE) index of a physical downlink control channel (PDCCH) candidate is determined/identified based on the received first configuration information.

The non-overlapped CCE index of the PDCCH candidate may be determined/identified based on a reference specified field value. The reference specified field value may be one of a plurality of specified field values included in the information of the mapping relationship described above. The reference specified field value may be determined/identified by a signaling received from the base station for indicating the reference specified field value, or the reference specified field value is determined/identified by a predefined rule, or the reference specified field value is predefined.

For example, the UE may select the reference specified field value from among a plurality of specified field values (e.g., CI fields) included in information of the mapping relationship. Here, the reference specified field value may be a maximum value, a minimum value, a predefined value of the plurality of specified field values. Alternatively, the base station may send a signaling including the reference specified field value to the UE, and the UE may match the specified field value with a predetermined/identified value among the received plurality of specified field values. The UE may then determine the non-overlapped CCE index of the PDCCH candidate based on the selected reference specified field value.

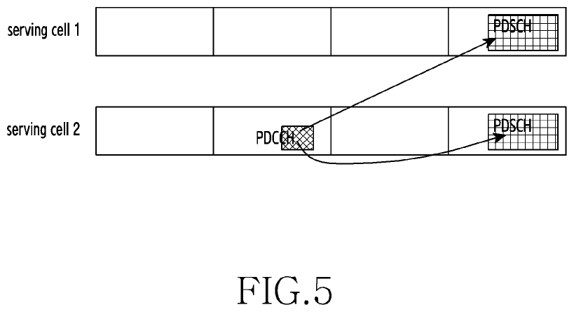

When the UE is configured with M serving cells (M is a positive integer), where a PDSCH/PUSCH of one of the M serving cells is self-carrier-scheduled by a PDCCH of the serving cell, and the PDSCHs/PUSCHs of the remaining M-1 serving cells are cross-carrier-scheduled by the PDCCH of the serving cell. For example, when the UE is configured with 2 serving cells, a serving cell 1 and a serving cell 2, where a PDSCH/PUSCH of the serving cell 1 is self-carrier-scheduled by a PDCCH of the serving cell 1, and a PDSCH/PUSCH of the serving cell 2 is cross-carrier-scheduled by the PDCCH of the serving cell 1, as shown in FIG. 5.

When the UE is not configured with one DCI scheduling a PDSCH/PUSCH of at least one serving cell, i.e., the DCI schedules a PDSCH/PUSCH of only one serving cell, a field in the DCI (e.g., a CI field (i.e., cif-InSchedulingCell, also noted as n_{CI}) indicates one serving cell, e.g., CI=000, a PDSCH of a serving cell 1 is scheduled; CI=001, a PDSCH of a serving cell 2 is scheduled; CI=010, a PDSCH of a serving cell 3 is scheduled; etc., as shown in Table 7. A CCE index of a PDCCH candidate is determined/identified by n_{CI} (i.e., cif-InSchedulingCell). For example, the CCE index of the PDCCH candidate may be calculated using Equation (1) above based on the field value of n_{CI}.

TABLE 7
The mapping relationship between the CI
field and the scheduled serving cell

| CI | scheduled serving cell |
|---|---|
| 000 | serving cell 1 |
| 001 | serving cell 2 |
| 010 | serving cell 3 |
| 011 | reserved |
| 100 | reserved |
| 101 | reserved |
| 110 | reserved |
| 111 | reserved |

When the UE is configured with one DCI scheduling a PDSCH/PUSCH of at least one serving cell, i.e., the one DCI may schedule multiple serving cells at the same time, the CCE index of the PDCCH candidate is determined/identified by a reference n_{CI}.

The reference n_{CI} may be determined/identified by the following methods.

### Method 1

The reference n_{CI} may be determined/identified by one of multiple cif-InSchedulingCells, and cif-InSchedulingCell in the scheduling serving cell is no longer used to indicate only one mapped scheduled serving cell. For example, in the following cases, when a specific indication method is that a field in the DCI (e.g., a CI field) is used to indicate a serving cell scheduled by the DCI, e.g., CI=000, a PDSCH of a serving cell 1 is scheduled; CI=001, PDSCHs of the serving cell 1 and a serving cell 2 are scheduled; CI=010, PDSCHs of the serving cell 1 and a serving cell 3 are scheduled, and the PDCCH candidates of the DCI at CI=000, CI=001 and CI=010 are the same (i.e., the CCE indexes are the same), the reference cif-InSchedulingCell may be one preset value of multiple CI field values, e.g., the reference cif-InSchedulingCell=CI=001. For another example, CI=011 , the PDSCH of the serving cell 2 is scheduled; CI=100, the PDSCHs of the serving cell 2 and the serving cell 3 are scheduled; CI=101, PDSCHs of the serving cell 3 and a serving cell 4 are scheduled, and the PDCCH candidates of the DCI at CI=011, CI=100, and CI=101 are the same, the reference cif-InSchedulingCell is a preset one of multiple CI field values, e.g., the reference cif-InSchedulingCell=CI=011. The preset value may be a maximum, minimum or specific value. In addition, the base station may send a signaling including the preset value to the UE such that the UE determines the CI field value in accordance with the preset value. The reference specified field value may be included in a plurality of specified field values included in the information of the mapping relationship.

After determining/identifying the reference n_{CI} , the CCE index of the PDCCH candidate may be calculated using Equation (1) above.

Using this method, by scheduling PDCCH candidates of different serving cell to share, the PDCCH candidates may be fully utilized to schedule different serving cells.

### Method 2

The reference n_{CI} may be determined/identified by cif-InSchedulingCell, but cif-InSchedulingCell in the scheduling serving cell is no longer used to indicate the mapped scheduled serving cell, and in the case of a determined/identified cif-InSchedulingCell, the scheduled serving cell is determined/identified by some other indication method, e.g., by a newly added field (e.g., a S field).

For example, when InSchedulingCell=L, a scheduled serving cell is indicated by the newly added field (e.g., the S field, e.g., S=000, a PDSCH of a serving cell 1 is scheduled; S=001, PDSCHs of the serving cell 1 and a serving cell 2 are scheduled; S=010, PDSCHs of the serving cell 1 and a serving cell 3 are scheduled). When InSchedulingCell=L, the PDCCH candidate of the DCI is the same and the CCE of the PDCCH candidate is determined/identified by InSchedulingCell=L.

For example, when InSchedulingCell=P, a scheduled serving cell is indicated by the newly added field (e.g., the S field, e.g., S=011, a PDSCH of a serving cell 2 is scheduled; S=100, PDSCHs of the serving cell 2 and a serving cell 3 are scheduled; S=101, PDSCHs of the serving cell 3 and a serving cell 4 are scheduled). When InSchedulingCell=P, the PDCCH candidate of the DCI is the same and the CCE of the PDCCH candidate is determined/identified by InSchedulingCell=P. After determining/identifying the reference n_{CI}, the index of the CCE of the PDCCH candidate may be calculated using Equation (1) above.

In case of using the newly added S field, the CI field in the DCI may be set to empty. The base station may send a signaling including the CI field value to the UE (i.e., implemented in the case of a determined/identified cif-InSchedulingCell), enabling the UE to determine the CCE index of the PDCCH candidate based on this CI field value.

### Method 3

The reference n_{CI} may be determined/identified by cif-InSchedulingCell, but cif-InSchedulingCell in the scheduling serving cell is used to indicate the mapped scheduled serving cell jointly with other fields.

For example, when the serving cell indication method is to indicate a scheduled serving cell by using an existing field in the DCI (e.g., the CI field) and a newly added field (e.g., the S field), e.g., CI=000 and S=000, a PDSCH of a serving cell 1 is scheduled; CI=000 and S=001, PDSCHs of the serving cell 1 and a serving cell 2 are scheduled, at this point, cif-InSchedulingCell=CI=000, and the PDCCH candidates of the DCI at CI=000 and S=000 and CI=000 and S=001 are the same, and the CCE of the PDCCH candidate is determined/identified by InSchedulingCell=000. For example, CI=001 and S=010, a PDSCH of the serving cell 2 is scheduled; CI=001 and S=011, PDSCHs of the serving cell 2 and the serving cell 3 are scheduled, at this point, cif-InSchedulingCell=CI=001, and the PDCCH candidates of the DCI at CI=001 and S=010, CI=001 and S=011 are the same and the CCE of the PDCCH candidate is determined/identified by InSchedulingCell=001.

When selecting the reference n_{CI}, a CI field value with a maximum value, a minimum value or a specific value may be selected. In addition, the base station may send a signaling including a preset value to the UE such that the UE determines the CI field value in accordance with the preset value. The reference specified field value may be included in a plurality of specified field values included in information of the mapping relationship.

After determining/identifying the reference n_{CI}, the CCE index of the PDCCH candidate may be calculated using Equation (1) above.

The method described above is used to enable the UE to fully share the blindly detected PDCCH candidate with a suitable PDCCH blind detection complexity.

At step S403, the DCI is detected based on the determined/identified non-overlapped CCE index. The user equipment may detect the DCI of simultaneously scheduling at least one serving cell based on the determined/identified non-overlapped CCE index.

The UE may detect the corresponding DCI based on the determined/identified non-overlapped CCE index in a search space of the configured serving cell.

The base station may set a search space identify, such as a search space ID, for the search space of the serving cell that the UE is configured with.

After receiving configuration information of the search space, the UE may know the search space IDs of the search spaces of the serving cells that it is configured with, and may configure the search spaces with the same search space IDs as a linked search space based on these search space IDs. The UE may detect the corresponding DCI in the linked search space, and thus schedule the serving cells indicated by the DCI. In this document, the search spaces linked with serving cells may also be referred to as the linked search space.

According to another example of the present disclosure, the user equipment may further receive second configuration information from the base station, the second configuration information includes configuration information of a search space, and then configure a linked search space of a scheduling serving cell with one of at least one scheduled serving cell based on the configuration information of the search space. The configuration information of the search space may include search space information elements as illustrated in Table 2 above. For example, if the search spaces of two serving cells have the same search space identify, the search spaces of the two serving cells may be used as the linked search space. When configuring the linked search space, the UE may determine the scheduling serving cell and the scheduled serving cell based on Table 2 above.

The scheduling serving cell may correspond to a plurality of search spaces, each of which may be linked with a different scheduled serving cell in at least one scheduled serving cell. For example, the scheduling serving cell has a plurality of search spaces, and the search space identify of each search space may be the same as the search space identify of a search space of a different scheduled cell, respectively, such that the plurality of search spaces of the scheduling serving cell are configured as linked search spaces with the search spaces of the different scheduled serving cells, respectively.

Further, the scheduling serving cell may correspond to one search space that may be linked with one of at least one scheduled serving cell. For example, the search space identify of one search space of the scheduling serving cell may be the same as the search space identify of one search space of one scheduled serving cell such that the search space of the scheduling serving cell is configured as a linked search space with the search space of the scheduled serving cell.

In this case, the UE may detect the corresponding DCI at a location corresponding to the determined/identified non-overlapped CCE index of the PDCCH candidate according to the configured linked search space.

For example, when the UE is configured with M serving cells (M is a positive integer), where a PDSCH/PUSCH of one of the M serving cells is self-carrier-scheduled by a PDCCH of the serving cell, and the PDSCHs/PUSCHs of the remaining M-1 serving cells are cross-carrier-scheduled by the PDCCH of the serving cell. For example, when the UE is configured with 4 serving cells, a serving cell 1, a serving cell 2, a serving cell 3 and a serving cell 4 respectively, where a PDSCH/PUSCH of the serving cell 1 is self-carrier-scheduled by a PDCCH of the serving cell 1, and PDSCH/PUSCHs of the serving cell 2, the serving cell 3 and the serving cell 4 are cross-carrier-scheduled by the PDCCH of the serving cell 1.

For a scheduled serving cell, the maximum number of monitored PDCCH candidates, denoted as M_{PDCCH}^{max,slot,μ}, is the maximum number of PDCCH candidates to be detected in a time slot μ for the scheduling of this serving cell. The number of PDCCH candidate detections for each scheduled serving cell is determined/identified by a high-layer signaling configuration or by a protocol, and is determined/identified by a search space configuration of each scheduled serving cell.

For a scheduled serving cell, the maximum number of non-overlapped CCEs, denoted as C_{PDCCH}^{max,slot,μ}, is the maximum number of non-overlapped CCEs occupied by PDCCH candidates for the scheduling of this serving cell within a time slot μ.

The DCI in the PDCCH schedules N serving cells out of M serving cells (N is less than or equal to M), and the N serving cells scheduled by the DCI may be indicated by a specified field in the DCI or by a newly added field.

The specific indication method may be that an existing field in the DCI (e.g., the CI field) is used. For example, CI=000, a PDSCH of a serving cell 1 is scheduled; CI=001, PDSCHs of the serving cell 1 and a serving cell 2 are scheduled; CI=011, PDSCHs of the serving cell 1 and a serving cell 3 are scheduled; etc.

The indication method may also be that a newly added field (e.g., the S field) is used. For example, S=000, a PDSCH of a serving cell 1 is scheduled; S=001, PDSCHs of the serving cell 1 and a serving cell 2 are scheduled; S=011, PDSCHs of the serving cell 1 and a serving cell 3 are scheduled; etc.

The indication method may also be that an existing filed (e.g., the CI field) and a newly added field (e.g., the S field) in the DCI are used. For example, CI=000 and S=000, a PDSCH of a serving cell 1 is scheduled; CI=000 and S=001, PDSCHs of the serving cell 1 and a serving cell 2 are scheduled; CI=001 and S=000, a PDSCH of a serving cell 3 is scheduled; CI=001 and S=001, PDSCHs of the serving cell 2 and the serving cell 3 are scheduled.

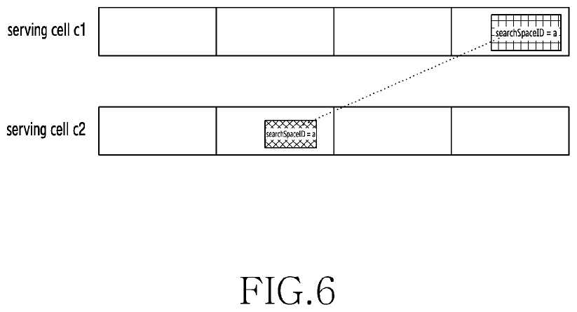

When the UE is not configured with one DCI for scheduling a PDSCH/PUSCH of at least one serving cell, the UE is configured with cross-carrier scheduling, and searchSpaceId of a search space configured for a scheduled serving cell c1 is a and searchSpaceId of a search space configured for a scheduling serving cell c2 is a, the search space configured for the scheduled serving cell and the search space of the scheduling serving cell are linked, and the PDCCH in the search space linked with the scheduling serving cell c2 schedules the PDSCH of the scheduled serving cell linked with the search space, as shown in FIG. 6. And the PDCCH candidate of this search space is calculated in this scheduled serving cell c1, so the CCE occupied by the PDCCH candidate of this linked search space is calculated in this scheduled serving cell c1, and the DCI payload size for blind detection within the PDCCH candidates of this linked search space is calculated in this scheduled serving cell c1.

The scheduling serving cell may correspond to one search space that may be linked with one of at least one scheduled serving cell.

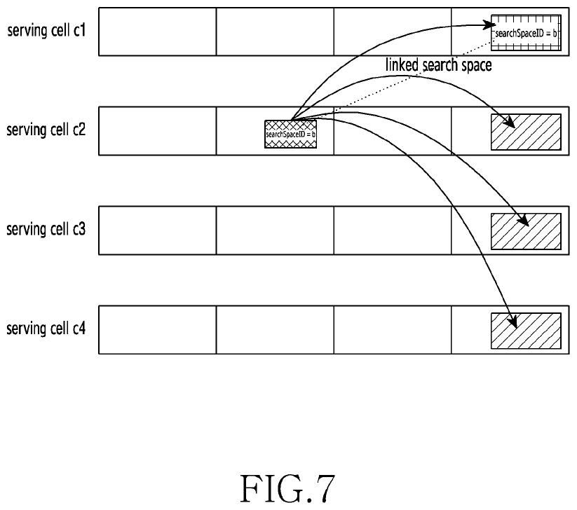

When the UE is configured with one DCI for scheduling a PDSCH/PUSCH of at least one serving cell, searchSpaceId of a search space of one scheduled serving cell c1 of scheduled serving cells is b, searchSpaceId of a search space of a scheduling serving cell c2 is b, the search space of the scheduled serving cell and the search space of the scheduling serving cell are configured as a linked search space b. The scheduled serving cell c1 is referred to as a reference scheduled serving cell, and the PDCCH in the linked search space b of the scheduling serving cell c2 may schedule the PDSCHs of the reference scheduled serving cell c1 and other serving cells (e.g., serving cells c3, c4), as shown in FIG. 7. And the PDCCH candidate of this linked search space b is calculated in this reference scheduled serving cell c1, thus the CCE occupied by the PDCCH candidate of this linked search space b is calculated in this reference scheduled serving cell c1, and the DCI payload size for blind detection within the PDCCH candidates of the search space is calculated in this reference scheduled serving cell c 1. The PDCCH candidate of this linked search space b is calculated in this reference scheduled serving cell c1 by using this configuration.

Another configuration may also be used to configure a search space with searchSpaceId=f of one scheduled serving cell c3 of scheduled serving cells and a search space with searchSpaceId=f of a scheduling serving cell c2 as a linked search space f. The scheduled serving cell c3 is referred to as the reference scheduled serving cell, and the PDCCH in the linked search space f of the scheduling serving cell c2 may schedule the PDSCHs of the reference scheduled serving cell c3 and other serving cells (e.g., serving cells c1, c4). And the PDCCH candidate of this linked search space f is calculated in this reference scheduled serving cell c3, thus the CCE occupied by the PDCCH candidate of this linked search space f is calculated in this reference scheduled serving cell c3, and the DCI payload size for blind detection within the PDCCH candidates of the search space is calculated in this reference scheduled serving cell. The PDCCH candidate of this linked search space f is calculated in this reference scheduled serving cell c3 by using this configuration.

The scheduling serving cell may correspond to a plurality of search spaces, and each of the plurality of search spaces may be linked with a different scheduled serving cell in at least one scheduled serving cell, respectively.

The present disclosure may employ a configuration that not only configures a search space with searchSpaceId=b of one scheduled serving cell c1 of scheduled serving cells and a search space with searchSpaceId=b of a scheduling serving cell c2 as a linked search space b, wherein the scheduled serving cell c1 is referred to as a reference scheduled serving cell, and the PDCCH in the linked search space b of the scheduling serving cell c2 may schedule the PDSCHs of the reference scheduled serving cell c1 and other serving cells (e.g., serving cells c3, c4), and the PDCCH candidate of this linked search space b is calculated in this reference scheduled serving cell c1, thus the CCE occupied by the PDCCH candidate of this linked search space b is calculated in this reference scheduled serving cell c1, and the DCI payload size for blind detection within the PDCCH candidates of the search space is calculated in this reference scheduled serving cell c1, but also configure a search space with searchSpaceId=f of one scheduled serving cell c3 of the scheduled serving cells and a search space with searchSpaceId=f of the scheduling serving cell c2 as a linked search space f, wherein the scheduled serving cell c3 is referred to as the reference scheduled serving cell, and the PDCCH in the linked search space f of the scheduling serving cell c2 may schedule the PDSCHs of the reference scheduled serving cell c3 and other serving cells (e.g., serving cells c1, c4), and the PDCCH candidate of this linked search space f is calculated in this reference scheduled serving cell c3, thus the CCE occupied by the PDCCH candidate of this linked search space f is calculated in this reference scheduled serving cell c3, and the DCI payload size for blind detection within the PDCCH candidates of the search space is calculated in this reference scheduled serving cell c3. The PDCCH candidate of this linked search space f is calculated in this reference scheduled serving cell c3 by using this configuration.

Using this configuration, a portion of PDCCH candidates through the linked search space b are calculated in the reference scheduled serving cell c1, and another portion of the PDCCH candidates through the linked search space f are calculated in the reference scheduled serving cell c3.

The advantage of using this method is that the number of PDCCH candidates of the linked search space b and/or f may be reasonably configured in the appropriate reference scheduled serving cell according to the number of PDCCH candidates for different scheduled serving cells simultaneously scheduled by a configured DCI, so that the number of PDCCH candidates of the scheduled serving cell does not exceed the maximum number of PDCCH candidates allowed.

At step S404, a PDSCH and/or PUSCH of at least one serving cell scheduled by the DCI are/is received based on the detected DCI.

In the present disclosure, the UE may detect the DCI corresponding to the determined/identified CCE in the linked search space and then schedule the serving cell(s) indicated by this DCI among the serving cells configured for the UE.

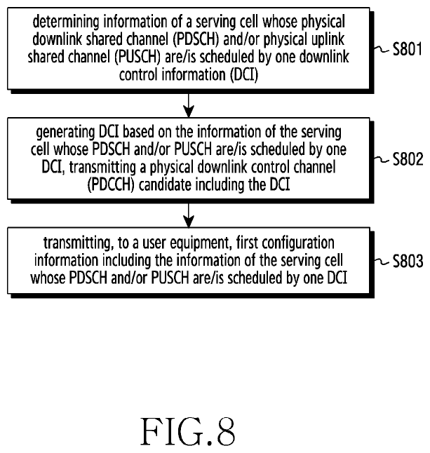

FIG. 8 illustrates a flowchart of a communication method performed by a base station in a communication system provided by an embodiment of the present application.

Referring to FIG. 8, at step S801, information of a serving cell whose physical downlink shared channel (PDSCH) and/or physical uplink shared channel (PUSCH) are/is scheduled by one downlink control information (DCI) is determined/identified.

The base station may pre-set a mapping relationship between a field in the DCI and simultaneously scheduled serving cells. The information of the serving cell whose PDSCH and/or PUSCH are/is scheduled by one DCI may include at least one of information of a mapping relationship between a specified field value in the DCI and at least one scheduled serving cell; information of a mapping relationship between a newly added field value in the DCI and at least one scheduled serving cell; information of a mapping relationship between a combination of a specified field value and a newly added field value in the DCI and at least one scheduled serving cell.. The specified field may be a carrier indicator (CI) field in the DCI.

DCI in a PDCCH schedules N serving cells out of M serving cells (N is less than or equal to M), and the N serving cells scheduled by the DCI may be indicated by an existing field and/or a newly added field in the DCI.

The specific indication method may be that an existing field in the DCI (e.g., the CI field, i.e., cif-InSchedulingCell, also noted as nu)) is used. For example, CI=000, a PDSCH of a serving cell 1 is scheduled; CI=001, PDSCHs of the serving cell 1 and a serving cell 2 are scheduled; CI=011, PDSCHs of the serving cell 1 and a serving cell 3 are scheduled; etc. For example, Table 4 illustrates the example mapping relationship between the CI field values and at least one scheduled serving cell.

The indication method may also be that a newly added field (e.g., the S field) is used. For example, S=000, a PDSCH of a serving cell 1 is scheduled; S=001, PDSCHs of the serving cell 1 and a serving cell 2 are scheduled; S=011, PDSCHs of the serving cell 1 and a serving cell 3 are scheduled; etc. For example, Table 5 illustrates the example mapping relationship between the S field values and at least one scheduled serving cell.

The indication method may also be that an existing filed (e.g., the CI field) and a newly added field (e.g., the S field) in the DCI are used. For example, CI=000 and S=000, a PDSCH of a serving cell 1 is scheduled; CI=000 and S=001, PDSCHs of the serving cell 1 and a serving cell 2 are scheduled; CI=001 and S=000, a PDSCH of a serving cell 3 is scheduled; CI=001 and S=001, PDSCHs of the serving cell 2 and the serving cell 3 are scheduled. For example, Table 6 illustrates the example mapping relationship between the CI and S field values and at least one scheduled serving cell.

The information of the serving cell whose PDSCH and/or PUSCH are/is scheduled by one DCI may be used by the user equipment to determine a non-overlapped control channel element (CCE) index of the PDCCH candidate.

According to an embodiment of the present disclosure, the base station may send an instruction including a reference specified field value to the user equipment, and the user equipment may determine the non-overlapped CCE index of the PDCCH candidate based on the reference specified field value. Alternatively, the user equipment may select a specified field value with a maximum value, a minimum value or a certain value as a referencenci .

When the UE is not configured with one DCI for scheduling a PDSCH/PUSCH of at least one serving cell, the field in the DCI is, for example, the CI field (i.e.,cif-InSchedulingCell, also noted as n_{CI})) e.g., CI=000, a PDSCH of a serving cell 1 is scheduled; CI=001, a PDSCH of a serving cell 2 is scheduled; CI=010, a PDSCH of a serving cell 3 is scheduled; etc., the CCE index of the PDCCH candidate may be determined/identified by n_{CI} (i.e., cif-InSchedulingCell), such as calculated using Equation (1) above.

When the UE is configured with one DCI for scheduling a PDSCH/PUSCH of at least one serving cell, the CCE index of the PDCCH candidate is determined/identified by a reference nci .

In the case where the serving cell is indicated by the CI field, the reference n_{CI} may be determined/identified by one cif-InSchedulingCell of a plurality of cif-InSchedulingCells, and cif-InSchedulingCell in the scheduling serving cell is no longer used to indicate only one mapped scheduled serving cell. For example, in the following cases, when a specific indication method is that a field in the DCI (e.g., a CI field) is used to indicate a serving cell scheduled by the DCI, e.g., CI=000, a PDSCH of a serving cell 1 is scheduled; CI=001, PDSCHs of the serving cell 1 and a serving cell 2 are scheduled; CI=010, PDSCHs of the serving cell 1 and a serving cell 3 are scheduled, and the PDCCH candidates of the DCI at CI=000, CI=001 and CI=010 are the same (i.e., the CCE indexes are the same), the reference cif-InSchedulingCell may be one preset value of multiple CI field values, e.g., the reference cif-InSchedulingCell=CI=001. For example, CI=011 , the PDSCH of the serving cell 2 is scheduled; CI=100, the PDSCHs of the serving cell 2 and the serving cell 3 are scheduled; CI=101, PDSCHs of the serving cell 3 and a serving cell 4 are scheduled, and the PDCCH candidates of the DCI at CI=011, CI=100, and CI=101 are the same, the reference cif-InSchedulingCell is a preset one of multiple CI field values, e.g., the reference cif-InSchedulingCell=CI=011.

In the case where the serving cell is indicated by the S field, the reference ncl may be determined/identified by cif-InSchedulingCell, but cif-InSchedulingCell in the scheduling serving cell is no longer used to indicate the mapped scheduled serving cell, and in the case of a determined/identified cif-InSchedulingCell, the scheduled serving cell is determined/identified by some other indication method, e.g., by a newly added field (e.g., a S field). For example, when InSchedulingCell=L, a scheduled serving cell is indicated by the newly added field (e.g., the S field, e.g., S=000, a PDSCH of a serving cell 1 is scheduled; S=001, PDSCHs of the serving cell 1 and a serving cell 2 are scheduled; S=010, PDSCHs of the serving cell 1 and a serving cell 3 are scheduled). When InSchedulingCell=L, the PDCCH candidate of the DCI is the same and the CCE of the PDCCH candidate is determined/identified by InSchedulingCell=L. For example, when InSchedulingCell=P, a scheduled serving cell is indicated by the newly added field (e.g., the S field, e.g., S=011, a PDSCH of a serving cell 2 is scheduled; S=100, PDSCHs of the serving cell 2 and a serving cell 3 are scheduled; S=101, PDSCHs of the serving cell 3 and a serving cell 4 are scheduled). When InSchedulingCell=P, the PDCCH candidate of the DCI is the same and the CCE of the PDCCH candidate is determined/identified by InSchedulingCell=P.

In the case where the serving cell is indicated by the CI field and the S field, The reference n_{CI} may be determined/identified by cif-InSchedulingCell, but cif-InSchedulingCell in the scheduling serving cell is used to indicate the mapped scheduled serving cell jointly with other fields. For example, when the serving cell indication method is to indicate a scheduled serving cell by using an existing field in the DCI (e.g., the CI field) and a newly added field (e.g., the S field), e.g., CI=000 and S=000, a PDSCH of a serving cell 1 is scheduled; CI=000 and S=001, PDSCHs of the serving cell 1 and a serving cell 2 are scheduled, at this point, cif-InSchedulingCell=CI=000, and the PDCCH candidates of the DCI at CI=000 and S=000 and CI=000 and S=001 are the same, and the CCE of the PDCCH candidate is determined/identified by InSchedulingCell=000. For example, CI=001 and S=010, a PDSCH of the serving cell 2 is scheduled; CI=001 and S=011, PDSCHs of the serving cell 2 and the serving cell 3 are scheduled, at this point, cif-InSchedulingCell=CI=001, and the PDCCH candidates of the DCI at CI=001 and S=010, CI=001 and S=011 are the same and the CCE of the PDCCH candidate is determined/identified by InSchedulingCell=001.

At step S802, DCI is generated based on the information of the serving cell whose PDSCH and/or PUSCH are/is scheduled by one DCI, a physical downlink control channel (PDCCH) candidate including the DCI is transmitted.

After the CI field or S field is configured, the corresponding DCI may be generated and the base station may send a PDCCH candidate including the DCI.

At step S803, first configuration information including the information of the serving cell whose PDSCH and/or PUSCH are/is scheduled by one DCI is transmitted to a user equipment.

The UE may, upon receiving the first configuration information, select a reference n_{CI}, and determine a non-overlapped CCE index of the PDCCH candidate to detect the DCI that one DCI schedules a PDSCH and/or PUSCH of at least one serving cell based on the non-overlapped CCE index.

Further, the base station may send second configuration information to the user equipment, and the second configuration information may include configuration information of a search space. Therein, the configuration information of the search space may be used to configure a linked search space of a scheduling serving cell with one of at least one scheduled serving cell.

According to an embodiment of the present disclosure, the base station may determine configuration information (such as including a search space identify/ID) of a search space of a serving cell configured for the user equipment, generate second configuration information based on the configuration information of the search space, and send, to the user equipment, the second configuration information which may include the configuration information of the search space. The configuration information of the search space may be used to configure a linked search space of the scheduling serving cell with one of the at least one scheduled serving cell.

The scheduling serving cell may correspond to a plurality of search spaces, and each of the plurality of search spaces may be linked with a different scheduled serving cell of the at least one scheduled serving cell, respectively. In addition, the scheduling serving cell corresponds to one search space that is linked with one of the at least one scheduled serving cells.

For example, in a case where the UE is configured with multiple serving cells, the base station may configure two search space IDs for a scheduling cell of the UE and one of the two search space IDs for one scheduled cells and the other of the two search space IDs for another scheduled serving cell, such that the scheduling cell may have linked search spaces with the scheduled cells, respectively. The above example is only exemplary, and the base station may configure different search space IDs for the serving cells configured for the UE. The user equipment may configure the linked search space based on the configuration information of the search space and detect the corresponding DCI at the location corresponding to the determined/identified non-overlapped CCE index of the PDCCH candidate based on the configured search space.

When the UE is not configured with one DCI for scheduling a PDSCH/PUSCH of at least one serving cell, the UE is configured with cross-carrier scheduling, and searchSpaceId of a search space configured for a scheduled serving cell c1 is a and searchSpaceId of a search space configured for a scheduling serving cell c2 is a and they are the same, the search space configured for the scheduled serving cell and the search space of the scheduling serving cell are linked, and the PDCCH in the search space linked with the scheduling serving cell c2 schedules the PDSCH of the scheduled serving cell linked with the search space, as shown in FIG. 6. And the PDCCH candidate of this search space is calculated in this scheduled serving cell c1, so the CCE occupied by the PDCCH candidate of this search space is calculated in this scheduled serving cell c1, and the DCI payload size for blind detection within the PDCCH candidates of this search space is calculated in this scheduled serving cell c1.

When the UE is configured with one DCI for scheduling a PDSCH/PUSCH of at least one serving cell, a search space of one scheduled serving cell c1 of scheduled serving cells and a search space of a scheduling serving cell c2 are configured as a linked search space s. The scheduled serving cell c1 is referred to as a reference scheduled serving cell, and the PDCCH in the linked search space s of the scheduling serving cell c2 may schedule the PDSCHs of the reference scheduled serving cell c1 and other serving cells (e.g., serving cells c3, c4), as shown in FIG. 7. And the PDCCH candidate of this linked search space s is calculated in this reference scheduled serving cell c1, thus the CCE occupied by the PDCCH candidate of this linked search space s is calculated in this reference scheduled serving cell c1, and the DCI payload size for blind detection within the PDCCH candidates of the search space is calculated in this reference scheduled serving cell c1.

When the UE is configured with one DCI for scheduling a PDSCH/PUSCH of at least one serving cell, a search space with searchSpaceId=b of one scheduled serving cell c1 of scheduled serving cells and a search space with searchSpaceId=b of a scheduling serving cell c2 are configured as a linked search space b, the scheduled serving cell c1 is referred to as a reference scheduled serving cell, and the PDCCH in the linked search space b of the scheduling serving cell c2 may schedule the PDSCHs of the reference scheduled serving cell c1 and other serving cells (e.g., serving cells c3, c4), and the PDCCH candidate of this linked search space b is calculated in this reference scheduled serving cell c1, thus the CCE occupied by the PDCCH candidate of this linked search space b is calculated in this reference scheduled serving cell c1, and the DCI payload size for blind detection within the PDCCH candidates of the search space is calculated in this reference scheduled serving cell c1. At the same time, a search space with searchSpaceId=f of one scheduled serving cell c3 of the scheduled serving cells and a search space with searchSpaceId=f of the scheduling serving cell c2 are configured as a linked search space f, the scheduled serving cell c3 is referred to as the reference scheduled serving cell, and the PDCCH in the linked search space f of the scheduling serving cell c2 may schedule the PDSCHs of the reference scheduled serving cell c3 and other serving cells (e.g., serving cells c1, c4), and the PDCCH candidate of this linked search space f is calculated in this reference scheduled serving cell c3, thus the CCE occupied by the PDCCH candidate of this linked search space f is calculated in this reference scheduled serving cell c3, and the DCI payload size for blind detection within the PDCCH candidates of the search space is calculated in this reference scheduled serving cell c3. The PDCCH candidate of this linked search space f is calculated in this reference scheduled serving cell c3 by using this configuration. Using this configuration, a portion of PDCCH candidates are calculated in the reference scheduled serving cell c1 through the linked search space b, and another portion of the PDCCH candidates are calculated in the reference scheduled serving cell c3 through the linked search space f.

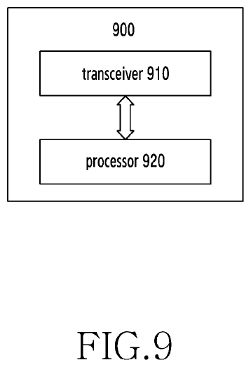

FIG. 9 illustrates a block diagram of a user equipment in a wireless communication system provided by an embodiment of the present application. Referring to FIG. 9, the user equipment 900 may include a transceiver 910 and a processor 920, wherein the processor 920 is coupled to the transceiver 910 and configured to perform the communication method performed by the UE described above.

Details of the operations of the method performed by the UE described above may refer to the description of FIGS. 4-7 and are not repeated here.

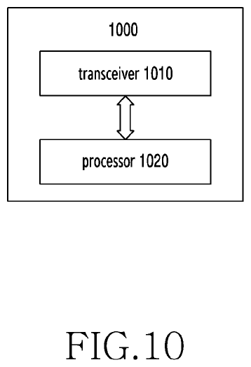

FIG. 10 illustrates a block diagram of a base station in a wireless communication system provided by an embodiment of the present application. Referring to FIG.10, the base station 1000 may include a transceiver 1010 and a processor 1020, wherein the processor 1020 is coupled to the transceiver 1010 and configured to perform the communication method performed by the base station described above.

Details of the operations of the method performed by the base station described above may refer to the description of FIG. 8 and are not repeated here.

According to the embodiments of the present disclosure, an electronic device is further provided, including: at least one processor; and at least one memory storing computer-executable instructions, wherein the computer-executable instructions, when run by the at least one processor, cause the at least one processor to perform any one of the methods as described above.

As an example, the electronic device may be a PC computer, a tablet device, a personal digital assistant, a smartphone, or any other device capable of executing the above instruction set. Here, the electronic device does not have to be a single electronic device, but may also be any set of devices or circuits capable of executing the above instructions (or instruction set) individually or jointly. The electronic device may also be a part of an integrated control system or system manager, or may be configured as a portable electronic device that interfaces locally or remotely (e.g., via wireless transmission).

In the electronic device, the processor may include a central processing unit (CPU), graphics processing unit (GPU), programmable logic device, special purpose processor system, microcontroller or microprocessor. By way of example and not limitation, the processor may also include analog processors, digital processors, microprocessors, multi-core processors, processor arrays, network processors, and the like.

The processor may execute instructions or code stored in the memory, which may also store data. Instructions and data may also be sent and received over a network via a network interface, which may employ any known transport protocol.

The memory may be integrated with the processor, e.g., a RAM or flash memory is arranged within an integrated circuit microprocessor or the like. Additionally, the memory may include a separate device such as an external disk drive, storage array, or any other storage device that may be used by a database system. The memory and the processor may be operatively coupled, or may communicate with each other, e.g., through I/O ports, network connections, etc., to enable the processor to read files stored in the memory.

In addition, the electronic device may also include video displays (e.g., liquid crystal display) and user interaction interfaces (e.g., keyboard, mouse, touch input device, etc.). All components of the electronic device may be connected to each other via a bus and/or a network.

In an embodiment of the present disclosure, a method performed by a user equipment in a communication system, wherein the method comprises: receiving, from a base station, first configuration information comprising information of a serving cell whose physical downlink shared channel (PDSCH) and/or physical uplink shared channel (PUSCH) are/is scheduled by one downlink control information (DCI); determining, based on the first configuration information, a non-overlapped control channel element (CCE) index of a physical downlink control channel (PDCCH) candidate; detecting the DCI based on the non-overlapped CCE index; receiving, based on the detected DCI, a PDSCH and/or a PUSCH of at least one serving cell scheduled by the DCI.

In an embodiment of the present disclosure, the information of the serving cell whose PDSCH and/or PUSCH are/is scheduled by one DCI comprises at least one of: information of a mapping relationship between a specified field value in the DCI and at least one scheduled serving cell; information of a mapping relationship between a newly added field value in the DCI and at least one scheduled serving cell; information of a mapping relationship between a combination of a specified field value and a newly added field value in the DCI and at least one scheduled serving cell.

In an embodiment of the present disclosure, the specified field is a carrier indicator (CI) field in the DCI.

In an embodiment of the present disclosure, the determining, based on the first configuration information, the non-overlapped CCE index of the PDCCH candidate comprises: determining the non-overlapped CCE index of the PDCCH candidate based on a reference specified field value, wherein the reference specified field value is one of a plurality of specified field values included in the information of the mapping relationship.

In an embodiment of the present disclosure, the reference specified field value is determined by a signaling received from the base station for indicating the reference specified field value; or the reference specified field value is determined by a predefined rule; or the reference specified field value is predefined.

In an embodiment of the present disclosure, further comprises: receiving, from the base station, second configuration information comprising configuration information of a search space; configuring, based on the configuration information of the search space, a linked search space of a scheduling serving cell with one of the at least one scheduled serving cell.

In an embodiment of the present disclosure, the scheduling serving cell corresponds to a plurality of search spaces, each of the plurality of search spaces is linked with a different scheduled serving cell of the at least one scheduled serving cell respectively; or the scheduling serving cell corresponds to one search space, the search space is linked with one scheduled serving cell of the at least one scheduled serving cell.

In an embodiment of the present disclosure, the detecting the DCI based on the non-overlapped CCE index comprising: detecting the DCI at a location corresponding to the non-overlapped CCE index of the PDCCH candidate, based on the linked search space; wherein the DCI is used to determine the at least one serving cell scheduled by the DCI among serving cells configured with the user equipment.

In an embodiment of the present disclosure, a method performed by a base station in a communication system, wherein the method comprises: determining information of a serving cell whose physical downlink shared channel (PDSCH) and/or physical uplink shared channel (PUSCH) are/is scheduled by one downlink control information (DCI); generating DCI based on the information of the serving cell whose PDSCH and/or PUSCH are/is scheduled by one DCI, transmitting a physical downlink control channel (PDCCH) candidate including the DCI; transmitting, to a user equipment, first configuration information comprising the information of the serving cell whose PDSCH and/or PUSCH are/is scheduled by one DCI; wherein the information of the serving cell whose PDSCH and/or PUSCH are/is scheduled by one DCI is used by the user equipment to determine a non-overlapped control channel element (CCE) index of the PDCCH candidate.

In an embodiment of the present disclosure, the information of the serving cell whose PDSCH and/or PUSCH are/is scheduled by one DCI comprises at least one of: information of a mapping relationship between a specified field value in the DCI and at least one scheduled serving cell; information of a mapping relationship between a newly added field value in the DCI and at least one scheduled serving cell; information of a mapping relationship between a combination of a specified field value and a newly added field value in the DCI and at least one scheduled serving cell.

In an embodiment of the present disclosure, the specified field is a carrier indicator (CI) field in the DCI.

In an embodiment of the present disclosure, further comprises: transmitting, to the user equipment, an instruction for indicating a reference specified field value, wherein the reference specified field value is used by the user equipment to determine the non-overlapped CCE index of the PDCCH candidate.

In an embodiment of the present disclosure, further comprises: transmitting, to the user equipment, second configuration information comprising configuration information of a search space; wherein the configuration information of the search space is used to configure a linked search space of a scheduling serving cell with one of at least one scheduled serving cell.

In an embodiment of the present disclosure, the scheduling serving cell corresponds to a plurality of search spaces, each of the plurality of search spaces is linked with a different scheduled serving cell of the at least one scheduled serving cell respectively; or the scheduling serving cell corresponds to one search space, the search space is linked with one scheduled serving cell of the at least one scheduled serving cell.

In an embodiment of the present disclosure, a user equipment, comprising: a transceiver; and a processor coupled to the transceiver and configured to perform a above mentioned methods.

In an embodiment of the present disclosure, a base station, comprising: a transceiver; and a processor, coupled to the transceiver and configured to perform above mentioned methods.

In an embodiment of the present disclosure, a user equipment (UE) comprising: a transceiver; and at least one processor coupled with the transceiver and configured to: receive, from a base station, first configuration information comprising information of a serving cell whose physical downlink shared channel (PDSCH) and/or physical uplink shared channel (PUSCH) are/is scheduled by one downlink control information (DCI); determine, based on the first configuration information, a non-overlapped control channel element (CCE) index of a physical downlink control channel (PDCCH) candidate; detect the DCI based on the non-overlapped CCE index; receive, based on the detected DCI, a PDSCH and/or a PUSCH of at least one serving cell scheduled by the DCI.

In an embodiment of the present disclosure, a base station comprising: a transceiver; and at least one processor coupled with the transceiver and configured to: determine information of a serving cell whose physical downlink shared channel (PDSCH) and/or physical uplink shared channel (PUSCH) are/is scheduled by one downlink control information (DCI); generate DCI based on the information of the serving cell whose PDSCH and/or PUSCH are/is scheduled by one DCI, transmitting a physical downlink control channel (PDCCH) candidate including the DCI; transmit, to a user equipment, first configuration information comprising the information of the serving cell whose PDSCH and/or PUSCH are/is scheduled by one DCI; wherein the information of the serving cell whose PDSCH and/or PUSCH are/is scheduled by one DCI is used by the user equipment to determine a non-overlapped control channel element (CCE) index of the PDCCH candidate.

According to an embodiment of the present disclosure, a method performed by a user equipment (UE) in a wireless communication system, the method comprising: receiving, from a base station, a first search space identifier (ID) for a first cell and a second search space ID for a second cell, the first search space ID and the second search space ID being same; receiving, from the base station on the first cell, first downlink control information (DCI) for scheduling a physical uplink shared channel (PUSCH) for one or more cells including the second cell, wherein at least one of a size of the first DCI, blind detection for the first DCI, or a control channel element (CCE) for the first DCI is based on a configuration of the second cell; and transmitting, to the base station, the PUSCH on the one or more cells based on the first DCI.

According to an embodiment of the present disclosure, further comprising: receiving, from the base station on the first cell, second DCI for scheduling a physical downlink shared channel (PDSCH) for the one or more cells including the second cell, wherein at least one of a size of the second DCI, blind detection for the second DCI, or a CCE for the second DCI is based on a configuration of the second cell; and receiving, from the base station, the PDSCH on the one or more cells based on the second DCI.

According to an embodiment of the present disclosure, the second cell is a reference cell among the one or more cells, for both of the first DCI and the second DCI.

According to an embodiment of the present disclosure, an index of the CCE for the first DCI is obtained based on a value configured for the one or more cells.

According to an embodiment of the present disclosure, a user equipment (UE) in a wireless communication system, the UE comprising: a transceiver; and a controller coupled with the transceiver and configured to: receive, from a base station, a first search space identifier (ID) for a first cell and a second search space ID for a second cell, the first search space ID and the second search space ID being same; receive, from the base station on the first cell, first downlink control information (DCI) for scheduling a physical uplink shared channel (PUSCH) for one or more cells including the second cell, wherein at least one of a size of the first DCI, blind detection for the first DCI, or a CCE for the first DCI is based on a configuration of the second cell; and transmit, to the base station, the PUSCH on the one or more cells based on the first DCI.

According to an embodiment of the present disclosure, the controller is further configured to: receive, from the base station on the first cell, second DCI for scheduling a physical downlink shared channel (PDSCH) for the one or more cells including the second cell, wherein at least one of a size of the second DCI, blind detection for the second DCI, or a CCE for the second DCI is based on a configuration of the second cell; and receive, from the base station, the PDSCH on the one or more cells based on the second DCI.

According to an embodiment of the present disclosure, the second cell is a reference cell among the one or more cells, for both of the first DCI and the second DCI.

According to an embodiment of the present disclosure, an index of the CCE for the first DCI is obtained based on a value configured for the one or more cells.

According to an embodiment of the present disclosure, a method performed by a base station in a wireless communication system, the method comprising: transmitting, to a user equipment (UE), a first search space identifier (ID) for a first cell and a second search space ID for a second cell, the first search space ID and the second search space ID being same; transmitting, to the UE on the first cell, first downlink control information (DCI) for scheduling a physical uplink shared channel (PUSCH) for one or more cells including the second cell, wherein at least one of a size of the first DCI, blind detection for the first DCI, or a control channel element (CCE) for the first DCI is based on a configuration of the second cell; and receiving, from the UE, the PUSCH on the one or more cells based on the first DCI.

According to an embodiment of the present disclosure, further comprising: transmitting, to the UE on the first cell, second DCI for scheduling a physical downlink shared channel (PDSCH) for the one or more cells including the second cell, wherein at least one of a size of the second DCI, blind detection for the second DCI, or a CCE for the second DCI is based on a configuration of the second cell; and transmitting, to the UE on the first cell, the PDSCH on the one or more cells based on the second DCI.

According to an embodiment of the present disclosure, the second cell is a reference cell among the one or more cells, for both of the first DCI and the second DCI.

According to an embodiment of the present disclosure, an index of the CCE for the first DCI is obtained based on a value configured for the one or more cells.

According to an embodiment of the present disclosure, a base station in a wireless communication system, the base station comprising: a transceiver; and a controller coupled with the transceiver and configured to: transmit, to a user equipment (UE), a first search space identifier (ID) for a first cell and a second search space ID for a second cell, the first search space ID and the second search space ID being same; transmit, to the UE on the first cell, first downlink control information (DCI) for scheduling a physical uplink shared channel (PUSCH) for one or more cells including the second cell, wherein at least one of a size of the first DCI, blind detection for the first DCI, or a control channel element (CCE) for the first DCI is based on a configuration of the second cell; and receive, from the UE, the PUSCH on the one or more cells based on the first DCI.

According to an embodiment of the present disclosure, the controller is further configured to: transmit, to the UE on the first cell, second DCI for scheduling a physical downlink shared channel (PDSCH) for the one or more cells including the second cell, wherein at least one of a size of the second DCI, blind detection for the second DCI, or a CCE for the second DCI is based on a configuration of the second cell; and transmit, to the UE on the first cell, the PDSCH on the one or more cells based on the second DCI.

According to an embodiment of the present disclosure, the second cell is a reference cell among the one or more cells, for both of the first DCI and the second DCI.

According to an embodiment of the present disclosure, a computer readable storage medium storing instructions is also provided. The instructions, when executed by at least one processor, causes the at least one processor to perform any of the above methods according to the exemplary embodiments of the present disclosure. Examples of computer-readable storage media herein include: read only memory (ROM), random access programmable read only memory (RAPROM), Electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, hard disk drive (HDD), solid state drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device, such as client, host, proxy device, server, etc. In addition, in one example, the computer programs and any associated data, data files, and data structures are distributed on a networked computer system, so that the computer programs and any associated data, data files, and data structures are stored, accessed and executed through one or more processors or computers in a distributed manner.

It should be noted that the terms “first,” “second,” “third,” “fourth,” “1,” “2,” etc. (if present)used in the specification and claims and the accompanying drawings above of the present application are used to distinguish similar objects and are not necessary for describing a particular order or sequence. It should be understood that the data so used is interchangeable in appropriate cases so that the embodiments of the present application described herein may be implemented in an order other than that illustrated or described herein.

It should be understood that while the flowcharts of the embodiments of the present application indicate the individual operational steps by arrows, the order of these implementation steps is not limited to the order indicated by the arrows. Unless explicitly stated herein, in some implementation scenarios of the embodiments of the present application, the implementation steps in the respective flowcharts may be performed in other orders as desired. In addition, some or all of the steps in each flowchart may include multiple sub-steps or multiple stages based on actual implementation scenarios. Some or all of these sub-steps or stages may be executed at the same moment, and each of these sub-steps or stages may also be executed separately at different moments. In the scenarios where the execution moments are different, the order of execution of these sub-steps or stages may be flexibly configured according to the needs, and the embodiments of the present application are not limited thereto.

The above description is only an optional implementation of part of the implementation scenarios of the present application. It should be noted that for those ordinary skill in the art, other similar means of implementation based on the technical idea of the present application, without departing from the technical idea of the present application, also fall within the scope of protection of the embodiments of the present application.

Other embodiments of the present disclosure will readily be conceived by those skill in the art after considering the specification and practicing the present disclosure. The present application is intended to cover any variation, use, or adaptation of the present disclosure that follows the general principle of the present disclosure and includes commonly known or customary technical means in the art not disclosed herein. The specification and embodiments are to be considered exemplary only, and the true scope and spirit of the disclosure is limited by the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, a first search space identifier (ID) for a first cell and a second search space ID for a second cell, the first search space ID and the second search space ID being same;
receiving, from the base station on the first cell, first downlink control information (DCI) for scheduling a physical uplink shared channel (PUSCH) for one or more cells including the second cell, wherein at least one of a size of the first DCI, a blind detection for the first DCI, or a control channel element (CCE) for the first DCI is based on a configuration of the second cell; and
transmitting, to the base station, the PUSCH on the one or more cells based on the first DCI.

2. The method of claim 1, further comprising:
receiving, from the base station on the first cell, second DCI for scheduling a physical downlink shared channel (PDSCH) for the one or more cells including the second cell, wherein at least one of a size of the second DCI, a blind detection for the second DCI, or a CCE for the second DCI is based on a configuration of the second cell; and
receiving, from the base station, the PDSCH on the one or more cells based on the second DCI.

3. The method of claim 2, wherein the second cell is a reference cell among the one or more cells for both of the first DCI and the second DCI.

4. The method of claim 1, wherein an index of the CCE for the first DCI is obtained based on a value configured for the one or more cells.

5. A user equipment (UE) in a wireless communication system, the UE comprising:
a transceiver; and
a controller coupled with the transceiver and configured to:
receive, from a base station, a first search space identifier (ID) for a first cell and a second search space ID for a second cell, the first search space ID and the second search space ID being same;
receive, from the base station on the first cell, first downlink control information (DCI) for scheduling a physical uplink shared channel (PUSCH) for one or more cells including the second cell, wherein at least one of a size of the first DCI, a blind detection for the first DCI, or a CCE for the first DCI is based on a configuration of the second cell; and
transmit, to the base station, the PUSCH on the one or more cells based on the first DCI.

6. The UE of claim 5, wherein the controller is further configured to:
receive, from the base station on the first cell, second DCI for scheduling a physical downlink shared channel (PDSCH) for the one or more cells including the second cell, wherein at least one of a size of the second DCI, a blind detection for the second DCI, or a CCE for the second DCI is based on a configuration of the second cell; and
receive, from the base station, the PDSCH on the one or more cells based on the second DCI.

7. The UE of claim 6, wherein the second cell is a reference cell among the one or more cells, for both of the first DCI and the second DCI.

8. The UE of claim 5, wherein an index of the CCE for the first DCI is obtained based on a value configured for the one or more cells.

9. A method performed by a base station in a wireless communication system, the method comprising:
transmitting, to a user equipment (UE), a first search space identifier (ID) for a first cell and a second search space ID for a second cell, the first search space ID and the second search space ID being same;
transmitting, to the UE on the first cell, first downlink control information (DCI) for scheduling a physical uplink shared channel (PUSCH) for one or more cells including the second cell, wherein at least one of a size of the first DCI, a blind detection for the first DCI, or a control channel element (CCE) for the first DCI is based on a configuration of the second cell; and
receiving, from the UE, the PUSCH on the one or more cells based on the first DCI.

10. The method of claim 9, further comprising:
transmitting, to the UE on the first cell, second DCI for scheduling a physical downlink shared channel (PDSCH) for the one or more cells including the second cell, wherein at least one of a size of the second DCI, a blind detection for the second DCI, or a CCE for the second DCI is based on a configuration of the second cell; and
transmitting, to the UE on the first cell, the PDSCH on the one or more cells based on the second DCI.

11. The method of claim 10, wherein the second cell is a reference cell among the one or more cells, for both of the first DCI and the second DCI.

12. The method of claim 9, wherein an index of the CCE for the first DCI is obtained based on a value configured for the one or more cells.

13. A base station in a wireless communication system, the base station comprising:
a transceiver; and
a controller coupled with the transceiver and configured to:
transmit, to a user equipment (UE), a first search space identifier (ID) for a first cell and a second search space ID for a second cell, the first search space ID and the second search space ID being same;
transmit, to the UE on the first cell, first downlink control information (DCI) for scheduling a physical uplink shared channel (PUSCH) for one or more cells including the second cell, wherein at least one of a size of the first DCI, a blind detection for the first DCI, or a control channel element (CCE) for the first DCI is based on a configuration of the second cell; and
receive, from the UE, the PUSCH on the one or more cells based on the first DCI.

14. The base station of claim 13, wherein the controller is further configured to:
transmit, to the UE on the first cell, second DCI for scheduling a physical downlink shared channel (PDSCH) for the one or more cells including the second cell, wherein at least one of a size of the second DCI, a blind detection for the second DCI, or a CCE for the second DCI is based on a configuration of the second cell; and
transmit, to the UE on the first cell, the PDSCH on the one or more cells based on the second DCI.

15. The base station of claim 14, wherein the second cell is a reference cell among the one or more cells, for both of the first DCI and the second DCI.

16. The base station of claim 13, wherein an index of the CCE for the first DCI is obtained based on a value configured for the one or more cells.
